(19) United States
(12) Patent Application Publication
(10) Pub. No.: US 2007/0254549 A1
(43) Pub. Date: Nov. 1, 2007

(54) Surface layer of an airbed or air mattress

(75) Inventor: Feng Liu, Shanghai (CN)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Bestway Inflatables & Material Corp.

(21) Appl. No.: 11/789,209

(22) Filed: Apr. 23, 2007

(30) Foreign Application Priority Data
Apr. 28, 2006 (CN) 200620041429.6

(51) Int. Cl. B32B 27/12; A47C 17/00

(52) U.S. Cl. 442/394; 442/396; 5/690

(57) ABSTRACT

A surface layer of an airbed or air mattress comprises a main layer, a reinforced layer, and an outer layer. The surface of the main layer is adhered together with the under-surface of the reinforced layer using an adhesive layer. The main layer is an inner layer of the airbed or air mattress. The reinforced layer is sandwiched between the inner layer and outer layer. The outer layer is a flocked layer adhered to the reinforced layer.

### FIELD OF THE INVENTION

The present utility model relates to an airbed or air mattress, and more particularly to a surface layer of an airbed or air mattress.

### BACKGROUND OF THE INVENTION

At present, inflatable products, such as airbeds and air mattresses, are becoming more and more popular in the market, because they are easy to carry and convenient to store. People not only use them as spare beds or air mattresses at home, but they also for outdoor camping and recreational activities, thus meeting the various needs of people's daily lives and leisure.

Generally, the formed surface layer of the airbed or air mattress of the current and existing technology is made with a single layer of polyvinyl chloride (PVC) or a single-layer flocked sheet of PVC. Because of their poor strength, their ability to stretch out of shape, and their poor ability to return to their original condition, these inflatable products contain the following obvious flaws: (1) because the internal air pressure value of the airbed or air mattress may drop after inflation, the airbed or air mattress may become too soft to use, and therefore may not be very comfortable for a user; and (2) the airbed or air mattress may easily, to some extent, lose its shape (become thinner) after inflation when a heavy load is placed on top of it. The internal air pressure value may drop below the recommended air pressure value, thus affecting the operational performance of the airbed or air mattress, and finally causing damage to or leakage of the formed surface layer, thus making the airbed or air mattress difficult to use.

### SUMMARY OF THE INVENTION

Aiming to correct the flaws of the existing technology, the purpose of the present utility model is to provide a kind of formed surface layer construction of an airbed or air mattress. It mainly comprises a main layer, a reinforced layer, and an outer layer. An adhesive layer can be used to adhere the surface of the main layer together with the undersurface of the reinforced layer. The main layer is made of a PVC sheet. The main layer is an inner layer of the airbed or air mattress and the reinforced layer is adhered between the inner layer and outer layer. The outer layer is a flocked layer, which is adhered to the surface of the reinforced layer. The reinforced layer has a shape of a network.

The advantage of the present utility model is that, by using a main layer plus a reinforced layer, the strength of the formed surface layer is not only greatly reinforced, but the stretch rate of the surface layer of the airbed can be significantly decreased. After inflation, the product may maintain a higher air pressure value and may not lose shape or become damaged, even under a heavy load. The overall quality of the product, as well as its comfort and durability, is improved remarkably. Meanwhile, the dead weight of the product is reduced, and the production costs are significantly decreased.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

### BRIEF DESCRIPTION OF THE DRAWINGS

FIG. 1 illustrates a cross-sectional view of the present utility model.

The following reference numbers will be used in the figure and the “Description of the Embodiments” to indicate like elements: 1. outer layer; 2. reinforced layer; 3. main layer; and 4. adhesive layer.

### DESCRIPTION OF THE EMBODIMENTS

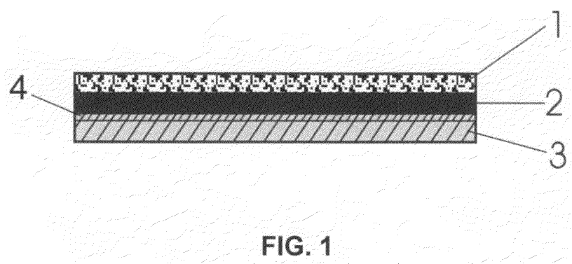

As shown in FIG. 1, a main layer 3 is made of a PVC sheet and a reinforced layer 2 is made of a nylon network. An adhesive layer 4 is sandwiched between the surface of the main layer 3 and the undersurface of the reinforced layer 2 to adhere the main layer 3 and the reinforced layer 2 together. The main layer 3 is an inner layer of the airbed or air mattress. The reinforced layer 2 is sandwiched between the inner layer (main layer 3) and the outer layer 1. The outer layer 1 is a flocked layer adhered to the surface of the reinforced layer 2 with a binder or by using an adhesive layer. The main layer 3 is adhered with the reinforced layer 2 and can be an extra flocked layer after the flocking process has been performed on the reinforced layer 2.

What is claimed is:

1. A surface layer of an airbed or air mattress comprising a main layer, a reinforced layer, and an outer layer, wherein the main layer is adhered together with the reinforced layer by an adhesive layer sandwiched therebetween, and wherein the main layer is an inner layer of the airbed or air mattress, and the reinforced layer is sandwiched between the inner layer and the outer layer, and the outer layer is a flocked layer adhered to the reinforced layer.

2. The surface layer of an airbed or air mattress according to claim 1, wherein the reinforced layer has a form of a network, and the main layer is made of a PVC sheet.
